(19) United States
(12) Patent Application Publication
(10) Pub. No.: US 2013/0330029 A1
(43) Pub. Date: Dec. 12, 2013

(54) HYDRODYNAMIC BEARING ASSEMBLY AND MANUFACTURING METHOD THEREOF

(71) Applicant: Sang Hyun KWON, Suwon (KR)

(72) Inventor: Sang Hyun KWON, Suwon (KR)

(73) Assignee: Samsung Electro-Mechnics Co., Ltd., Suwon (KR)

(21) Appl. No.: 13/570,510

(22) Filed: Aug. 9, 2012

(30) Foreign Application Priority Data
Jun. 12, 2012 (KR) 10-2012-0062897

(51) Int. Cl. F16C 32/06; B21D 53/10

(52) U.S. Cl. 384/121; 384/100; 29/898.02

(57) ABSTRACT

There are provided a hydrodynamic bearing assembly and a manufacturing method thereof. The hydrodynamic bearing assembly includes: an oil sealing part formed between a fixed member and a rotating member; and a silicon containing diamond-like-carbon (Si-DLC) or tungsten carbide (W-Carbide) coating layer formed on at least one surface of the fixed member and the rotating member. The silicon containing diamond-like-carbon (Si-DLC) or tungsten carbide (W-Carbide) coating layer is formed on the at least one surface of the fixed member and the rotating member, whereby abrasion of the fixed member and the rotating member due to friction therebetween may be prevented.

### CROSS-REFERENCE TO RELATED APPLICATIONS

This application claims the priority of Korean Patent Application No. 10-2012-0062897 filed on Jun. 12, 2012, in the Korean Intellectual Property Office, the disclosure of which is incorporated herein by reference.

### BACKGROUND OF THE INVENTION

1. Field of the Invention

The present invention relates to a hydrodynamic bearing assembly capable of preventing abrasion of a fixed member and a rotating member due to friction therebetween, and a manufacturing method thereof.

2. Description of the Related Art

A hard disk drive (HDD), an information storage device, reads data stored on a disk or writes data to a disk using a read/write head.

A hard disk drive requires a disk driving device capable of driving the disk. In the disk driving device, a small spindle motor is used.

This small spindle motor has used a hydrodynamic bearing assembly. A shaft, a rotating member of the hydrodynamic bearing assembly, and a sleeve, a fixed member thereof, have a lubricating fluid interposed therebetween, such that the shaft is supported by fluid pressure generated in the lubricating fluid.

Further, in the spindle motor including the hydrodynamic bearing assembly, a fluid sealing part is configured using fluid surface tension and a capillary phenomenon. In the sealing part, stability is an important factor.

However, due to friction between fixed members and rotating members caused by continuous driving of the motor, motor driving may be deteriorated or stopped, such that driving stability of the motor may be deteriorated.

Therefore, research into technology for reducing friction between rotating members and fixed members due to the driving of a motor and preventing abrasion of the rotating members and fixed members to improve driving stability of the motor has been urgently demanded.

In a dynamic bearing apparatus according to the related art, an attempt to form a carbon protective film on surfaces of a shaft of a bearing and a sleeve of a rotor to reduce abrasion of the bearing has been undertaken. However, it may take an excessively long time to form the carbon protective film, such that a satisfactory effect may not be obtained therefrom.
(Patent Document 1) Japanese Patent Laid-Open Publication No. 1999-062947

### SUMMARY OF THE INVENTION

An aspect of the present invention provides a hydrodynamic bearing assembly capable of preventing abrasion of a fixed member and a rotating member due to friction therebetween, and a manufacturing method thereof.

According to an aspect of the present invention, there is provided a hydrodynamic bearing assembly including: an oil sealing part formed between a fixed member and a rotating member; and a silicon containing diamond-like-carbon (Si-DLC) or tungsten carbide (W-Carbide) coating layer formed on at least one surface of the fixed member and the rotating member.

The coating layer may have a thickness of 0.5 to 5 μm.

In the silicon containing diamond-like-carbon (Si-DLC) coating layer, a silicon (Si) layer and a diamond-like carbon (DLC) layer may be sequentially formed on the at least one surface of the fixed member and the rotating member.

The fixed member may be at least one selected from a group consisting of a sleeve and a cap.

The rotating member may be at least one selected from a group consisting of a shaft, a thrust plate, and a hub.

According to another aspect of the present invention, there is provided a manufacturing method of a hydrodynamic bearing assembly, the manufacturing method including: preparing a fixed member and a rotating member including an oil sealing part formed therebetween; forming a silicon containing diamond-like-carbon (Si-DLC) or tungsten carbide (W-Carbide) coating layer on at least one surface of the fixed member and the rotating member; and filling the oil sealing part with lubricating oil such that a liquid-vapor interface is formed in the oil sealing part.

The coating layer may have a thickness of 0.5 to 5 μm.

In the forming of the silicon containing diamond-like-carbon (Si-DLC) coating layer, a silicon (Si) layer and a diamond-like carbon (DLC) layer may be sequentially formed on the at least one surface of the fixed member and the rotating member.

The forming of the coating layer may be performed by a chemical vapor deposition (CVD) method or a physical vapor deposition (PVD) method.

The forming of the coating layer may be performed by a plasma enhanced chemical vapor deposition (PECVD) method.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a cross-sectional view schematically showing a motor including a hydrodynamic bearing assembly according to a first embodiment of the present invention;

FIG. 2 is a cross-sectional view schematically showing a motor including a hydrodynamic bearing assembly according to a second embodiment of the present invention; and

FIG. 3 is a cross-sectional view schematically showing a motor including a hydrodynamic bearing assembly according to a third embodiment of the present invention.

### DETAILED DESCRIPTION OF THE INVENTION

Embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art. In the drawings, the shapes and dimensions may be exaggerated for clarity, and the same reference numerals will be used throughout to designate the same or like components.

Embodiments of the present invention will now be described in detail with reference to the accompanying drawings.

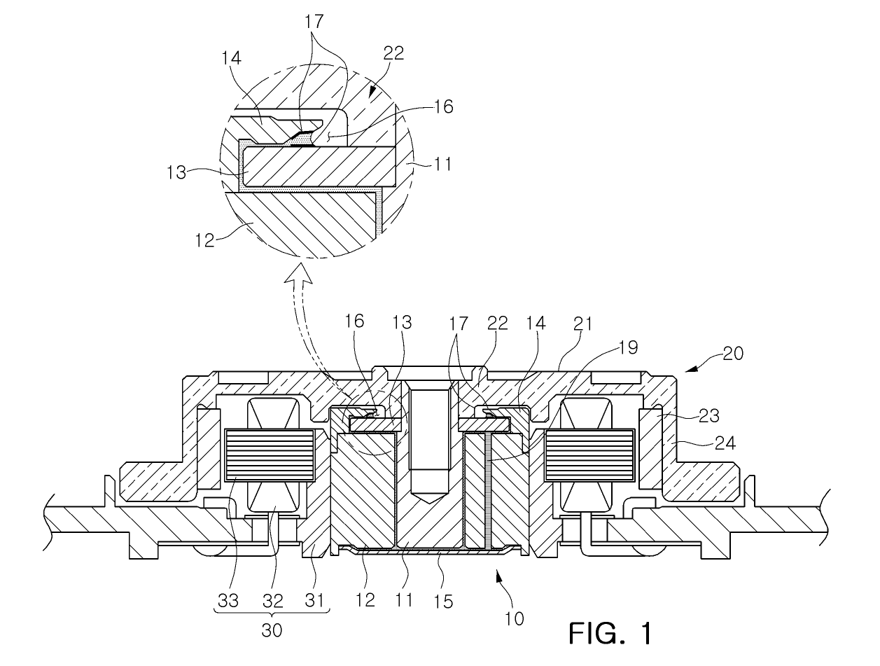

FIG. 1 is a cross-sectional view schematically showing a motor including a hydrodynamic bearing assembly according to a first embodiment of the present invention.

Referring to FIG. 1, a hydrodynamic bearing assembly 10 according to the first embodiment of the present invention may include an oil sealing part 16 formed between fixed members 12 and 14 and rotating members 11, 13, and 22; and a silicon containing diamond-like-carbon (Si-DLC) or tungsten carbide (W-Carbide) coating layer 17 formed on at least one surface of the fixed members 12 and 14 and the rotating members 11, 13, and 22.

Hereinafter, the above configuration will be described in detail.

The fixed members may include a sleeve 12 and a cap 14, and the rotating members may include a shaft 11, a thrust plate 13, and a hub 22.

The oil sealing part 16 may be formed between the fixed members 12 and 14 and the rotating members 11, 13, and 22, particularly, between the sleeve 12, the thrust plate 13, and the cap 14.

The cap 14 may be a member press-fitted onto an upper portion of the thrust plate 13 to allow lubricating oil 19 to be sealed between the cap 14 and the thrust plate 13, and include a circumferential groove formed in an outer diameter direction so as to be press-fitted onto the thrust plate 13 and the sleeve 12.

The cap 14 may include a protrusion part formed at a lower surface thereof in order to seal the lubricating oil 19, which uses a capillary phenomenon and surface tension of the lubricating oil in order to prevent the lubricating oil 19 from leaking to the outside at the time of the driving of the motor.

The hydrodynamic bearing assembly 10 according to the embodiment of the present invention may include the silicon containing diamond-like-carbon (Si-DLC) or tungsten carbide (W-Carbide) coating layer 17 formed on at least one surface of the fixed members 12 and 14 and the rotating members 11, 13, and 22.

In the silicon containing diamond-like-carbon (Si-DLC) coating layer 17, a silicon (Si) layer and a diamond-like-carbon (DLC) layer may be sequentially formed on at least one surface of the fixed members 12 and 14 and the rotating members 11, 13, and 22.

In addition, the coating layer 17 formed on at least one surface of the fixed members 12 and 14 and the rotating members 11, 13, and 22 may include tungsten-carbide.

According to the embodiment of the present invention, the silicon containing diamond-like-carbon (Si-DLC) or tungsten carbide (W-Carbide) coating layer 17 is formed on at least one surface of the fixed members 12 and 14 and the rotating members 11, 13, and 22, whereby friction between the fixed members 12 and 14 and the rotating members 11, 13, and 22 due to continuous driving of the motor may be reduced.

In addition to the reduction in friction between the fixed members 12 and 14 and the rotating members 11, 13, and 22, abrasion of the fixed members 12 and 14 and the rotating members 11, 13, and 22 may be prevented, such that driving stability of the motor may be improved.

A method of forming the silicon containing diamond-like-carbon (Si-DLC) or tungsten carbide (W-Carbide) coating layer 17 on at least one surface of the fixed members 12 and 14 and the rotating members 11, 13, and 22 is not specifically limited. For example, the silicon containing diamond-like-carbon (Si-DLC) or tungsten carbide (W-Carbide) coating layer 17 may be formed by a deposition process.

Particularly, the silicon containing diamond-like-carbon (Si-DLC) or tungsten carbide (W-Carbide) coating layer 17 may be formed by a chemical vapor deposition (CVD) method or a physical vapor deposition (PVD) method.

In the case in which the silicon containing diamond-like-carbon (Si-DLC) or tungsten carbide (W-Carbide) coating layer 17 is formed by the physical vapor deposition (PVD) method, adhesion between a base material and the coating layer may be improved, such that a friction coefficient may be reduced and abrasion may be thus reduced.

In the chemical vapor deposition (CVD) method, various kinds of gas may be used as a raw material and a deposition time may be short to thereby increase process efficiency. Therefore, the chemical vapor deposition (CVD) method may be advantageous to coat silicon containing diamond-like-carbon (Si-DLC) or tungsten carbide (W-Carbide).

The silicon containing diamond-like-carbon (Si-DLC) or tungsten carbide (W-Carbide) coating layer 17 may be formed as a thin film by the deposition process as described above.

Meanwhile, the silicon containing diamond-like-carbon (Si-DLC) or tungsten carbide (W-Carbide) coating layer 17 may also be formed by a plasma enhanced chemical vapor deposition (PECVD) method.

According to the embodiment of the present invention, the silicon containing diamond-like-carbon (Si-DLC) or tungsten carbide (W-Carbide) coating layer 17 is formed by the plasma enhanced chemical vapor deposition (PECVD) method, such that a coating time may be reduced to thereby improve process efficiency.

In addition, various kinds of gas may be used as a raw material, such that various performances of the coating layer may be implemented according to the type of gas used.

A thickness of the silicon containing diamond-like-carbon (Si-DLC) or tungsten carbide (W-Carbide) coating layer 17 is not particularly limited, but may be, for example, 0.5 to 5 μm.

The silicon containing diamond-like-carbon (Si-DLC) or tungsten carbide (W-Carbide) coating layer 17 is formed as a thin film having a thickness of 0.5 to 5 μm, such that the friction between the fixed members 12 and 14 and the rotating members 11, 13, and 22 may be reduced and abrasion of the fixed members 12 and 14 and the rotating members 11, 13, and 22 may be prevented, whereby the driving stability of the motor may be improved.

In the case in which the thickness of the silicon containing diamond-like-carbon (Si-DLC) or tungsten carbide (W-Carbide) coating layer 17 is below 0.5 μm, the thickness of the coating layer 17 may be excessively thin, such that abrasion performance of the coating layer may be deteriorated.

In the case in which the thickness of the silicon containing diamond-like-carbon (Si-DLC) or tungsten carbide (W-Carbide) coating layer 17 is greater than 5 μm, the thickness of the coating layer is excessively thick, such that the driving of the motor may be difficult.

Meanwhile, the hydrodynamic bearing assembly 10 according to the embodiment of the present invention may include the shaft 11, the sleeve 12, the thrust plate 13, the cap 14, and the oil sealing part 16.

The sleeve 12 may support the shaft 11 so that an upper end of the shaft 11 protrudes upwardly in an axial direction and may be formed by forging copper (Cu) or aluminum (Al) or sintering a copper-iron (Cu—Fe) based alloy powder or an SUS based powder.

In this configuration, the shaft 11 may be inserted into a shaft hole of the sleeve 12 so as to have a micro clearance therewith. The micro clearance may be filled with lubricating fluid, and rotation of the rotor 20 may be smoothly supported by a radial dynamic pressure groove (not shown) formed in at least one of an outer surface of the shaft 11 and an inner surface of the sleeve 12.

The radial dynamic pressure groove may be formed in the inner surface of the sleeve 12, an inner portion of the shaft hole of the sleeve 12 and generate pressure so that the shaft 11 is biased toward one side at the time of rotation thereof.

However, the radial dynamic pressure groove is not limited to being formed in the inner surface of the sleeve 12 as described above, but may also be formed in the outer surface of the shaft 11. In addition, the number of radial dynamic pressure grooves is not limited.

Here, the sleeve 12 may include a cover plate 15 coupled thereto at a lower portion thereof, having a clearance therebetween, wherein the clearance receives lubricating fluid therein.

The cover plate 15 may receive the lubricating fluid in the clearance between the cover plate 15 and the sleeve 12 to serve as a bearing supporting a lower surface of the shaft 11.

The thrust plate 13 may be disposed upwardly of the sleeve 120 in the axial direction and include a hole corresponding to a cross section of the shaft 11 at the center thereof such that the shaft 110 may be inserted into the hole.

Here, the thrust plate 13 may be separately manufactured and then coupled to the shaft 11 or may be formed integrally with the shaft 11 at the time of manufacturing thereof and rotate together with the shaft 11 at the time of the rotation of the shaft 11.

In addition, the thrust plate 13 may include a thrust dynamic pressure groove formed in an upper surface thereof, wherein the thrust dynamic pressure groove provides thrust dynamic pressure to the shaft 11.

The thrust dynamic pressure groove is not limited to being formed in the upper surface of the thrust plate 13 as described above, but may also be formed in an upper surface of the sleeve 12 corresponding to a lower surface of the thrust plate 13.

A stator 30 may include a coil 32, cores 33, and a base member 31.

In other words, the stator 30 may be a fixed structure including the coil 32 generating electromagnetic force having a predetermined magnitude at the time of the application of power and a plurality of the cores 33 having the coil 32 wound therearound.

The core 33 may be fixedly disposed on an upper portion of the base member 31 on which a printed circuit board (not shown) having circuit patterns printed thereon is provided, and a plurality of coil holes having a predetermined size may penetrate an upper surface of the base member 31 corresponding to the coil 32 in order to expose the coil 32 downwardly, and the coil 32 may be electrically connected to the printed circuit board (not shown) such that external power is supplied thereto.

The rotor 20, a rotating structure rotatably provided with respect to the stator 30, may include a rotor case 21 having an annular ring-shaped magnet 23 provided on an outer peripheral surface thereof, and the annular ring-shaped magnet 23 corresponds to the core 33, while having a predetermined interval therebetween.

In addition, the magnet 23 may be a permanent magnet generating magnetic force having a predetermined strength by alternately magnetizing an N pole and an S pole thereof in a circumferential direction.

Here, the rotor case 21 may include a hub base 22 press-fitted onto the upper end of the shaft 11 to be fixed thereto and a magnet support part 24 extended from the hub base 22 in the outer diameter direction and bent downwardly in the axial direction to support the magnet 23.

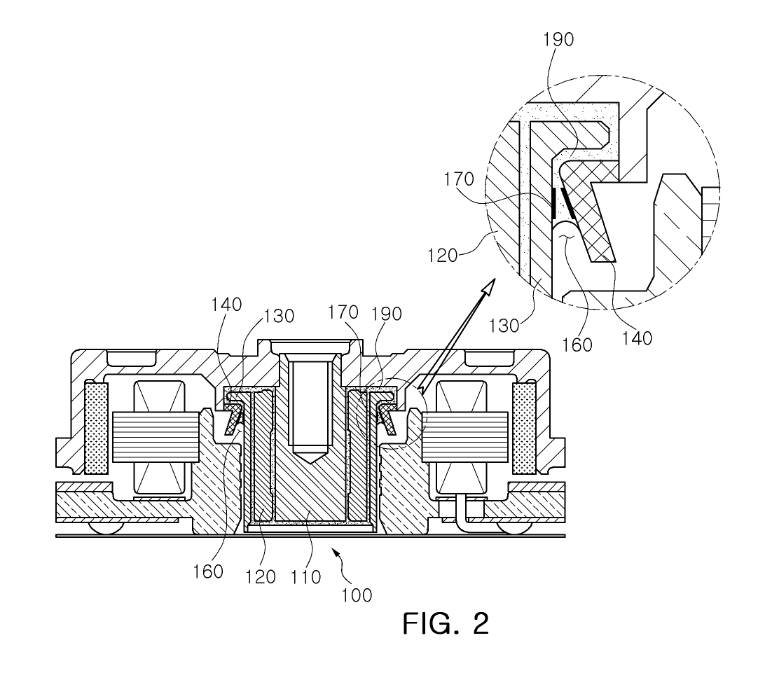

FIG. 2 is a cross-sectional view schematically showing a motor including a hydrodynamic bearing assembly according to a second embodiment of the present invention.

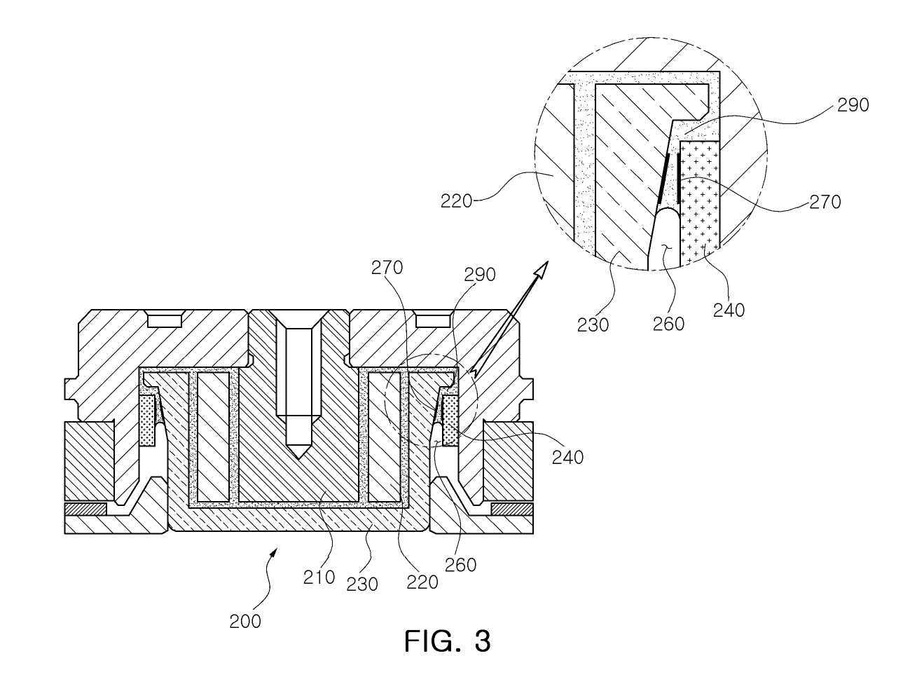

FIG. 3 is a cross-sectional view schematically showing a motor including a hydrodynamic bearing assembly according to a third embodiment of the present invention.

Motors including hydrodynamic bearing assemblies 100 and 200 according to the second and third embodiments of the present invention are shown in FIGS. 2 and 3.

The hydrodynamic bearing assembly 100 or 200 according to the second or third embodiment of the present invention may include an oil sealing part 160 or 260 formed between fixed members 120 or 220 and 140 or 240 and rotating members 110 or 210 and 130 or 230; and a silicon containing diamond-like-carbon (Si-DLC) or tungsten carbide (W-Carbide) coating layer 170 or 270 formed on at least one surface of the fixed members 120 or 220 and 140 or 240 and the rotating members 110 or 210 and 130 or 230.

Features other than the above-mentioned feature of the hydrodynamic bearing assembly 100 or 200 are the same as those of the hydrodynamic bearing assembly 10 according to the first embodiment of the present invention described above. Therefore, a description thereof will be omitted.

Meanwhile, a manufacturing method of the hydrodynamic bearing assembly 10 according to an embodiment of the present invention may include preparing fixed members and rotating members having an oil sealing part formed therebetween; forming a silicon containing diamond-like-carbon (Si-DLC) or tungsten carbide (W-Carbide) coating layer on at least one surface of the fixed members and the rotating members; and filling the oil sealing part with lubricating oil such that a liquid-vapor interface is formed in the oil sealing part.

The coating layer may have a thickness of 0.5 to 5 μm.

The forming of the coating layer may be performed by a chemical vapor deposition (CVD) method or a physical vapor deposition (PVD) method.

In the forming of the silicon containing diamond-like-carbon (Si-DLC) coating layer, a silicon (Si) layer and a diamond-like carbon (DLC) layer may be sequentially formed on at least one surface of the fixed members and the rotating members.

In addition, the forming of the coating layer may be performed by a plasma enhanced chemical vapor deposition (PECVD) method.

The manufacturing method of the hydrodynamic bearing assembly 10 according to the embodiment of the present invention may be the same as a general manufacturing method of a hydrodynamic bearing assembly except for the above-mentioned feature.

Hereinafter, a feature of the manufacturing method of the hydrodynamic bearing assembly 10 according to another embodiment of the present invention will be described in detail. However, a description of features overlapped with those of the hydrodynamic bearing assembly described above and a general manufacturing process will be omitted.

In the manufacturing method of the hydrodynamic bearing assembly 10 according to the embodiment of the present invention, the fixed members and the rotating members having the oil sealing part formed therebetween may first be prepared.

The fixed members and the rotating members are not particularly limited. Examples of the fixed members and the rotating members have been described above.

Next, the silicon containing diamond-like-carbon (Si-DLC) or tungsten carbide (W-Carbide) coating layer may be formed on at least one surface of the fixed members and the rotating members. Then, the oil sealing part may be filled with the lubricating oil such that the liquid vapor interface is formed in the oil sealing part.

Particularly, in the case of the forming of the silicon containing diamond-like-carbon (Si-DLC) coating layer on at least one surface of the fixed members and the rotating members, the silicon (Si) layer and the diamond-like carbon (DLC) layer may be sequentially formed.

More specifically, an air washing process may be performed on at least one surface of the fixed members and the rotating members.

Next, diamond-like-carbon (DLC) is coated on at least one surface of the fixed members and the rotating member via silicon (Si), such that the silicon (Si) layer and the diamond-like carbon (DLC) layer may be sequentially formed.

The forming of the coating layer may, in particular, be performed by a plasma enhanced chemical vapor deposition (PECVD) method.

In the case in which the coating layer is formed by the plasma enhanced chemical vapor deposition (PECVD) method as described above, a process time may be reduced as compared to a method according to the related art, such that process efficiency may be improved.

More specifically, in the case of forming the coating layer by a coating method according to the related art, an average time required for an air washing process and a chrome and diamond-like carbon (DLC) deposition process is 240 minutes. On the other hand, according to an embodiment of the present invention, an average time required for an air washing process and a silicon and diamond-like carbon (DLC) deposition process may be 60 minutes.

That is, in the case of forming the coating layer according to the embodiment, the process time may be reduced to a time corresponding to about ¼ of a process time according to the related art, such that process efficiency may be improved.

In the following Table 1, coating materials, chemical bonding, and coating times are compared in the case of using the silicon containing diamond-like-carbon (Si-DLC) coating layer according to Inventive Example of the present invention and in the case of using a general diamond-like carbon (DLC) coating layer according to Comparative Example.

TABLE 1

| | Silicon containing | |
|---|---|---|
| | diamond-like-carbon | General Diamond-Like |
| | (Si-DLC) | Carbon (DLC) |
| | (PECVD) | (CVD) |
| Coating Material | Si, DLC | Cr, DLC |
| Chemical | Si Bonding | Metal Bonding |
| Bonding | Si—C Bonding | Metal-C Bonding |
| | C—C Bonding(DLC) | C—C Bonding (DLC) |
| Coating Time | Washing Process | Washing Process |
| | (15 minutes) | (30 minutes) |
| | Si Layer (15 minutes) | Cr Layer (90 minutes) |
| | DLC Layer (30 minutes) | DLC Layer (120 minutes) |
| Total Coating | 60 minutes | 240 minutes |
| Time | | |

In the following Table 2, thicknesses of the coating layers, thin film hardness, and friction coefficients in hydrodynamic bearing assemblies in which the silicon containing diamond-like-carbon (Si-DLC) coating layer and the tungsten-carbide (W-carbide) coating layer are used are compared with each other.

TABLE 2

| | Silicon containing | Tungsten-Carbide |
|---|---|---|
| | diamond-like-carbon (Si-DLC) | (W-Carbide) |
| | Coating Layer | Coating Layer |
| Coating Thickness | 1.5 | 2~4 |
| (μm) | | |
| Thin Film Hardness | 29.1 | 28.9 |
| (GPa) | | |
| Friction | 0.2 | 0.15 |
| Coefficient | | |

It could be appreciated from Table 2 that in the case in which the silicon containing diamond-like-carbon (Si-DLC) or tungsten-carbide (W-carbide) coating layer is applied to fixed members or rotating members, surface hardness increases, while a friction coefficient decreases, such that abrasion of the fixed members and rotating members due to friction therebetween may be prevented.

As set forth above, according to the embodiments of the present invention, the silicon containing diamond-like-carbon (Si-DLC) or tungsten carbide (W-Carbide) coating layer is formed on at least one surface of the fixed members and the rotating members, whereby abrasion of the fixed members and the rotating members due to friction therebetween may be prevented.

In addition, the silicon containing diamond-like-carbon (Si-DLC) coating layer is formed, such that a process time may be reduced as compared to the case of using a general diamond-like carbon (DLC) coating layer, thereby improving productivity.

Further, the silicon containing diamond-like-carbon (Si-DLC) coating layer is formed on at least one surface of the fixed members and the rotating members, such that surface hardness of the members increases, while a friction coefficient thereof decreases, whereby damage of contact parts between the fixed members and the rotating members may be prevented and thus, the motor may be continuously used.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
an oil sealing part formed between a fixed member and a rotating member; and
a silicon containing diamond-like-carbon (Si-DLC) or tungsten carbide (W-Carbide) coating layer formed on at least one surface of the fixed member and the rotating member.

2. The hydrodynamic bearing assembly of claim 1, wherein the coating layer has a thickness of 0.5 to 5 μm.

3. The hydrodynamic bearing assembly of claim 1, wherein in the silicon containing diamond-like-carbon (Si-DLC) coating layer, a silicon (Si) layer and a diamond-like carbon (DLC) layer are sequentially formed on the at least one surface of the fixed member and the rotating member.

4. The hydrodynamic bearing assembly of claim 1, wherein the fixed member is at least one selected from a group consisting of a sleeve and a cap.

5. The hydrodynamic bearing assembly of claim 1, wherein the rotating member is at least one selected from a group consisting of a shaft, a thrust plate, and a hub.

6. A manufacturing method of a hydrodynamic bearing assembly, the manufacturing method comprising:
preparing a fixed member and a rotating member including an oil sealing part formed therebetween;
forming a silicon containing diamond-like-carbon (Si-DLC) or tungsten carbide (W-Carbide) coating layer on at least one surface of the fixed member and the rotating member; and
filling the oil sealing part with lubricating oil such that a liquid-vapor interface is formed in the oil sealing part.

7. The manufacturing method of claim 6, wherein the coating layer has a thickness of 0.5 to 5 μm.

8. The manufacturing method of claim 6, wherein in the forming of the silicon containing diamond-like-carbon (Si-DLC) coating layer, a silicon (Si) layer and a diamond-like carbon (DLC) layer are sequentially formed on the at least one surface of the fixed member and the rotating member.

9. The manufacturing method of claim 6, wherein the forming of the coating layer is performed by a chemical vapor deposition (CVD) method or a physical vapor deposition (PVD) method.

10. The manufacturing method of claim 6, wherein the forming of the coating layer is performed by a plasma enhanced chemical vapor deposition (PECVD) method.
